(19) United States
(12) Patent Application Publication
(10) Pub. No.: US 2025/0153527 A1
(43) Pub. Date: May 15, 2025

(54) SUSPENSION SYSTEM AND SUSPENSION CONTROL METHOD OF AUTOMATIC GUIDED VEHICLE

(71) Applicant: Fulian Yuzhan Precision Technology Co., Ltd., Shenzhen (CN)

(72) Inventors: BO LONG, Shenzhen (CN); ZHI WANG, Shenzhen (CN)

(21) Appl. No.: 18/941,279

(22) Filed: Nov. 8, 2024

(30) Foreign Application Priority Data
Nov. 10, 2023 (CN) 202311497927.6

(51) Int. Cl. B60G 17/015

(52) U.S. Cl. CPC B60G 17/0157; B60G 2202/12; B60G 2500/20

(57) ABSTRACT

The present application provides a suspension system with a first connection module, a second connection module slidably assembled on the first connection module, a main spring between the first connection module and the second connection module, an auxiliary spring, a motor, a transmission mechanism, a sensor, and a controller. A first end of the auxiliary spring is disposed on the second connection module. While a detection result of the sensor is satisfied with a first predefined condition, the controller controls the motor to drive the transmission mechanism for compressing the auxiliary spring; while the detection result of the sensor is satisfied with a second predefined condition, the controller controls the motor to drive the transmission mechanism for lifting up the second connection module in related to the first connection module, and the main spring is compressed. A suspension control method of an AGV is also provided.

### FIELD

The present application relates to the field of automated guided vehicle technology, in particular relates to a suspension system and a suspension control method of an automated guided vehicle.

### BACKGROUND

Since an automated guided vehicle (AGV) is highly automated and intelligent, it is widely applied to various application scenarios such as warehousing, manufacturing, logistics, and hazardous working environments.

For example, AGVs are used in a warehouse for various functions such as moving shelving racks or moving goods between shelves or stacking goods etc. AGVs are also used to transport other objects such as boxes or goods around an environment e.g. around a warehouse. Often multiple AGVs are used in an indoor environment e.g. in a warehouse. Environments AGVs are used in can be uneven and have uneven surface, such as for example an uneven floor in a warehouse. AGVs include suspension systems that attempt to adapt to uneven surfaces. Current suspension systems still cause unstable movement in some situations and can cause instability of the AGV during acceleration and deceleration.

Therefore, it is necessary to provide a suspension system for an AGV that assists in levelling the AGV or provide the public with a useful alternative.

### BRIEF DESCRIPTION OF THE DRAWINGS

In order to more clearly illustrate the technical solutions of the embodiments of the present application, the following will briefly introduce the accompanying drawings that need to be used in the embodiments. Obviously, the accompanying drawings in the following description are only some embodiments of the present application. Those of ordinary skill in the art can also obtain other drawings based on these drawings without paying creative labor.

FIG. 1 is a schematic view of a suspension system provided by one embodiment of the present application;

FIG. 2 is a partially exploded schematic view of a suspension system provided by one embodiment of the present application;

FIG. 3 is a schematic view of the suspension system from another aspect of FIG. 2;

FIG. 4 is a schematic view of the suspension system moving on a plane, showing a transmission mechanism of the suspension system in a first state, provided by one embodiment of the present application;

FIG. 5 is a schematic view of the suspension system passing through a concave ground, showing a transmission mechanism of the suspension system in a second state, provided by one embodiment of the present application;

FIG. 6 is a schematic view of the suspension system passing through a convex ground, showing a transmission mechanism of the suspension system in a third state, provided by one embodiment of the present application;

FIG. 7 is a schematic view of the suspension system with a slide track and a slider being assembled together, provided by one embodiment of the present application;

FIG. 8 is a schematic view of the suspension system and walking parts assembled together, provided by one embodiment of the present application;

FIG. 9 is a schematic view of the AGV, provided by one embodiment of the present application;

FIG. 10 is a schematic view of a suspension system, walking parts, and a vehicle frame being assembled together, provided by one embodiment of the present application.

### DETAILED DESCRIPTION

The present embodiment of the application discloses a suspension system, with a main spring disposed between a first connection module and a second connection module, is capable of compressing an auxiliary spring by using a motor to drive a transmission mechanism while walking parts pass through a concave ground, which compensates a support force of the main spring, thus a shake of a vehicle frame may be avoided or reduced, and a stability of an automated guided vehicle (AGV) is improved. The suspension system is also capable of rising the second connection module up by using a motor to drive a transmission mechanism and compressing the main spring while the walking parts pass through a convex ground, the increased support force of the main spring is offset, thus a movement of the vehicle frame maybe avoided or reduced and the stability of the AGV is improved. The embodiments of the present application also disclose an AGV with the suspension system and a suspension control method of the AGV for improving a stability of the vehicle frame. In order to better understand the technical solutions of the present application, the embodiments of the present application will be described in detail below in conjunction with the accompanying drawings. It should be clear that the described embodiments are only some of the embodiments of the present application, not all of the embodiments. Based on the embodiments of this application, all other embodiments obtained by persons of ordinary skill in the art without creative efforts fall within the protection scope of this application.

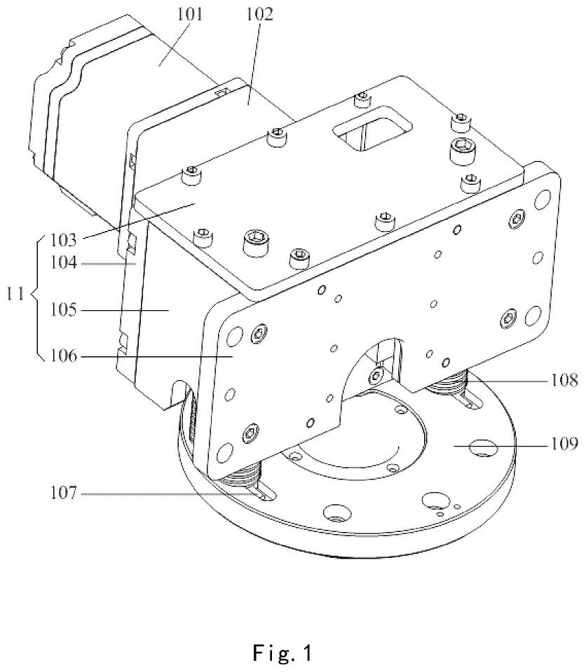

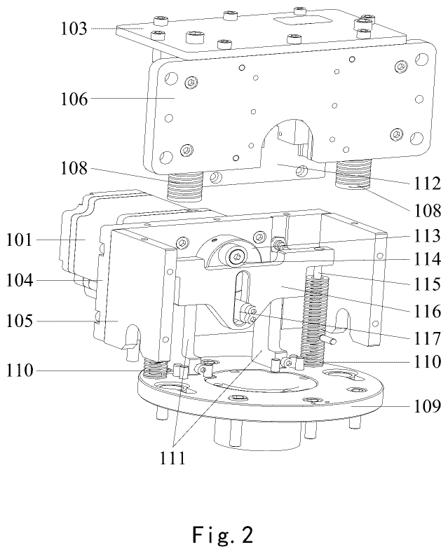

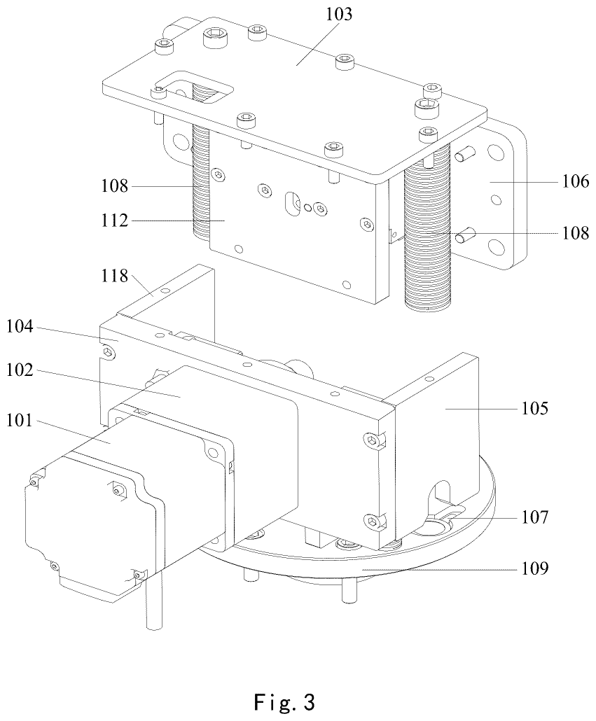

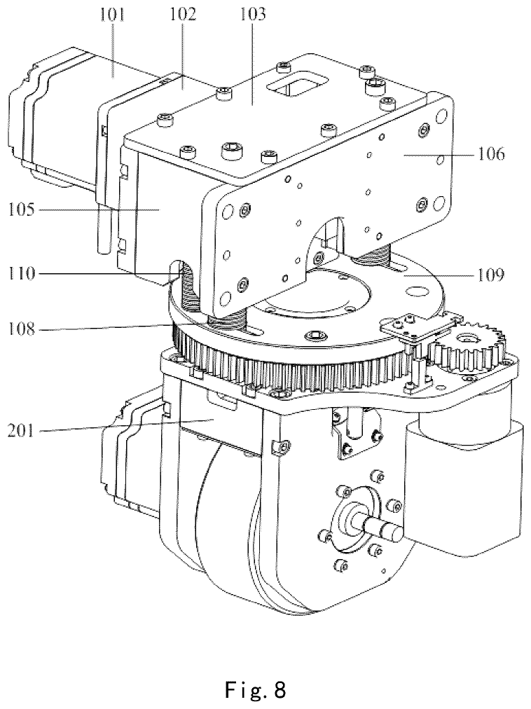

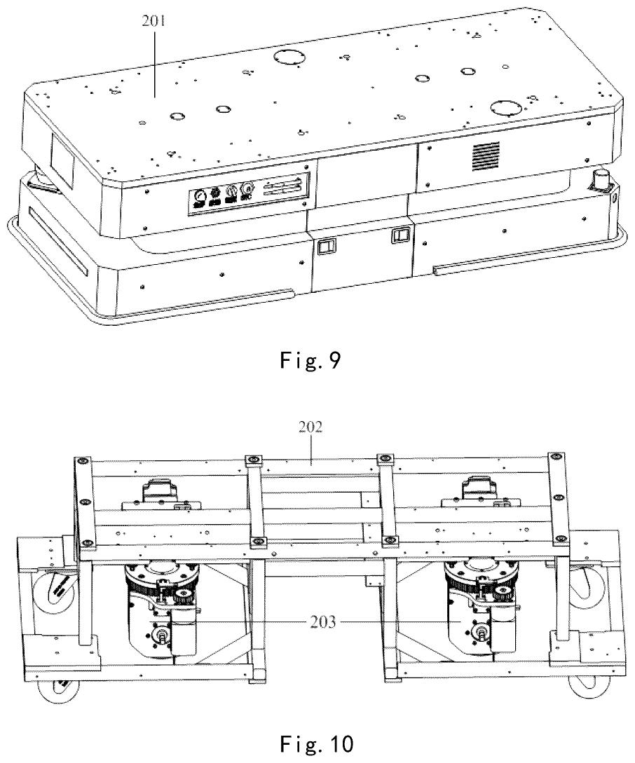

Referring to FIGS. 1-10, the embodiment of the present application provides a suspension system, which includes a first connection module 11, a second connection module 12, a main spring 108, an auxiliary spring 110, a motor 101, a transmission mechanism 13, a sensor 107, and a controller. The second connection module 12 is slidably assembled on the first connection module 11. The main spring 108 is disposed between the first connection module 11 and the second connection module 12.

The auxiliary spring 110 includes a first end and a second end. The first end of the auxiliary spring 110 is disposed on the second connection module 12. The motor 101 is assembled on the first connection module 11. The transmission mechanism 13 is connected with the motor 101, and acts on the second end of the auxiliary spring 110. The transmission mechanism 13 driven by the motor 101 is used to compress the auxiliary spring 110 or the main spring 108. The sensor 107 is assembled on the first connection module 11 or the second connection module 12. The sensor 107 is used to sense a force and/or a length of the main spring 108. The controller controls the motor 101 to drive the transmission mechanism 13 for compressing the auxiliary spring 110 while a detection result of the sensor 107 is satisfied with a first predefined condition, and controls the motor 101 to drive the transmission mechanism 13 for moving and rising the second connection module 12 in related to the first connection module 11 while the detection result of the sensor 107 is satisfied with a second predefined condition, thus the main spring 108 is compressed.

While the suspension system is used in the AGV, the first connection module 11 is fixed on a vehicle frame 202 of the AGV, and walking parts 203 are assembled on the second connection module 12.

The first predefined condition includes a support force of the main spring 108 is decreased or the length of the main spring 108 gets longer by comparing with an initial state of the main spring 108. The second predefined condition includes the support force of the main spring 108 is increased or the length of the main spring 108 gets shorter by comparing with the initial state of the main spring 108. The support force and the length of the main spring 108 while the AGV drives on a plane road are served as the support force and the length of the main spring 108 in the initial state respectively.

While the AGV passes through the concave ground, the walking parts 203 move forward and are tightly contacted with the concave ground respectively, and the second connection module 12 moves down with the walking parts 203, the main spring 108 is stretched and the support force of the main spring 108 is decreased, the first predefined condition reaches. The controller controls the motor 101 to drive the transmission mechanism 13 for acting, and the transmission mechanism 13 compresses the auxiliary spring 110, a length of the auxiliary spring 110 gets shorter, and a force of the auxiliary spring 110 is increased for compensating the decreased support force of the main spring 108, thus a sum support force applied on the first connection module 11 has a little change or remains unchanged, and violent shakes of the first connection module 11 and the vehicle frame 202 connected with the first connection module 11 are avoided. The sum support force applied on the first connection module 11 includes the support force of the main spring 108 and the support force of the auxiliary spring 110.

While the AGV passes through the convex ground, the walking parts 203 move forward and are tightly contacted with the convex ground, and the second connection module 12 moves upwards with the walking parts 203, the main spring 108 is compressed, the length of the main spring 108 gets shorter, and the support force of the main spring 108 is increased, the second predefined condition reaches. The controller controls the motor 101 to drive the transmission mechanism 13 for acting, and the transmission mechanism 13 lifts up the second connection module 12 for offsetting a part or the whole of the increased support force of the main spring 108, therefore a sum support force applied on the first connection module 11 has a little change or remains unchanged, and violent shakes of the first connection module 11 and the vehicle frame 202 connected with the first connection module 11 are avoided. The sum support force applied on the first connection module 11 includes the support force of the main spring 108 and the force applied on the first connection module 11 by the transmission mechanism 13 and the motor 101 while the second connection module 12 is lifted up.

Therefore, by using the suspension system provided by the present application, a shaking degree of the vehicle frame 202 is capable of being reduced while the AGV passes through the uneven ground, and the stability and a trafficability of the AGV are improved.

In some embodiments, while the suspension system is assembled on the AGV and is in an using state, the second connection module 12 may slip relative to the first connection module 11 along a perpendicular direction. The suspension system further includes a reducer 102. The motor 101 drives the transmission mechanism 13 to act by the reducer 102.

The suspension system also includes the sensor 107 and the controller. The sensor 107 is assembled on the first connection module 11 or the second connection module 12. The sensor 107 is used to sense the force and/or the length of the main spring 108. The controller determines whether the detection result of the sensor 107 is satisfied with the first predefined condition or the second predefined condition, and controls the motor 101 to rotate based on a determining result.

The first connection module 11 includes a top plate 103 and a plurality of side plates. The side plates are connected end to end. The top plate 103 is fixedly connected with the side plates. The second connection module 11 further includes a flange 109, a vertical plate 112, and a fixed plate 119. The vertical plate 112 is fixed on the flange 109. The fixed plate 119 is fixed on the vertical plate 112. The fixed plate and the flange 109 are disposed on opposite ends of the vertical plate 112 respectively.

In some embodiments, the transmission mechanism 13 includes a sliding member 116, a rotating disc 113, and a bearing 114. The rotating disc 113 and the bearing 114 form an eccentric cam.

The eccentric cam cooperates with the motor 101 to form an eccentric module.

The sliding member 116 is assembled on the second connection module 12. The first end of the auxiliary spring 110 resists the second connection module 12. The second end of the auxiliary spring 110 resists with the sliding member 116.

In one embodiment, the rotating disc 113 is directly fixed on an output shaft of the motor 101. The motor 101 drives the rotating disc 113 to rotate along an axis of the rotating disc 113. In another embodiment, while the motor 101 drives the transmission mechanism 13 by the reducer 102, the rotating disc 113 is fixed on an output shaft of the reducer 102. The output shaft of the reducer 102 drives the rotating disc 113 to rotate along the axis of the rotating disc 113.

The bearing 114 is assembled on the rotating disc 113. An axis of the bearing 114 is offset the axis of the rotating disc 113, and is parallel with the axis of the rotating disc 113.

While the fires predefined condition is satisfied, the motor 101 drives the rotating disc 113 to rotate along the axis of the rotating disc 113, the bearing 114 pushes the sliding member 116 to slide in related to the second connection module 12. While the sliding member 116 slides, the auxiliary spring 110 is compressed, thus the supporting force of the main spring 108 is compensated by the compressed auxiliary spring 110. When the second predefined condition is satisfied, the motor 101 drives the rotating disc 113 to rotate along the axis of the rotating disc 113, the bearing 114 resist with the second connection module 12 and lifts up the second connection module 12 in related to the first connection module 11, for compressing the main spring 108.

In the embodiment, while the motor 101 directly drives the transmission mechanism 13, the rotating disc 113 is fixed on the output shaft of the motor 101, and the axis of the rotating disc 113 is overlapped with the output shaft of the motor 101. While the motor 101 drives the transmission mechanism 13 by the reducer 102, the rotating disc 113 is fixed on the output shaft of the reducer 102. The sliding member 116 resists with the bearing 114.

In one embodiment, the bearing 114 includes an outer ring portion and an inner ring portion. The inner ring portion is fixed on the rotating disc 113, and the outer ring portion is rotatably assembled on the inner ring portion. The outer ring portion of the bearing 114 resists with the sliding member 116 and is used to lift up the second connection module 12. While the rotating disc 113 rotates, the outer ring portion rotates in related to the inner ring portion, for reducing a revolving resistance of the rotating disc 113.

In addition, in the suspension system provided by the present application, the sliding member 116 remains resisting with the bearing 114. In an initial state, that is the AGV drives on the plane, the auxiliary spring 110 with a pre-pressure provides a driving force to the sliding member 116 for resisting with the bearing 114. While the AGV with the suspension system passes through the convex ground, the bearing 114 lifts up the second connection module 12 in related to the first connection module 11, the sliding member 116 remains being resisted with the bearing 114 by the function of auxiliary spring 110, and provides an assistance driving force to the bearing 114, for reducing a torque of the motor 101. Therefore, it is convenience to use the motor 101 with a model in a smaller specification size, and a volume and a weight of the motor 101 are reduced.

The sliding member 116 also may be set as not being always resisted with the bearing 114. While in the initial state, it means that the AGV drives on the plane and under the first predefined condition, the sliding member 116 resist with the bearing 114. While under the second predefined condition, the sliding member 116 is distanced from the bearing 114.

In an example of using the sensor 107 to sense the force of the main spring 108, the controller is capable of computing a difference between the force of the main spring 108 and a predefined value, and controlling the motor 101 to rotate for adjusting a rotating angle of the rotating disc 113 according to the computed difference. The predefined value is the force of the main spring 108 while the AGV drives on the plane, and is acquired by a detecting operation of the sensor 107.

When the computed difference is a positive value, the controller controls the rotating disc 113 to rotate along a first direction for allowing the bearing 114 to lift up the second connection module 12. The controller computes a compressed of the main spring 108 corresponding to the computed difference, and then computes a rotating angle of the rotating disc 113 while a lift distance of the second connection module 12 in related to the first connection module 11 reaches the computed compressed. The controller further controls the motor 101 to rotate, thus a rotating angle of the rotating disc 113 along the first direction in related to an original position reaches at the foregoing computed rotating angle. The original position is a position of the rotating disc 113 while the AGV drives on the plane.

When the computed difference is a negative value, the controller controls the rotating disc 113 to rotate along a second direction for allowing the bearing 114 to press the sliding member 116 and compress the auxiliary spring 110. The second direction is opposite to the first direction. The computed difference is a force of the auxiliary spring 110 needed to be increased in related to an initial force. The controller computes a compressed of the auxiliary spring 110 being compressed by the sliding member 116 according to the computed difference, and then computes the rotating angle of the rotating disc 113 according to the computed compressed. The controller further controls the motor 101 to rotate, thus the rotating angle of the rotating disc 113 along the second direction in related to an original position reaches the computed rotating angle. The initial force is the force of the auxiliary spring 110 while the AGV drives on the plane.

The suspension system provided by the present application is capable of intelligently determining a displacement of the walking part 203 by the sensor 107 while the AGV passes through the concave ground or the convex ground, and automatically driving the rotating disc 113 to rotate for achieving an intelligent compensation. An effect of an adaptive ground situation is achieved. The stability and the trafficability of the AGV are ensured, and a performance and a market competitive power of the AGV are improved.

Optionally, in the foregoing suspension system, the sliding member 116 defines a sliding slot 1161, the second connection module 12 is fixed with a guiding block 117. The guiding block 117 inserts into the sliding slot 1161, and is used to guide a sliding direction of the sliding member 116 in related to the second connection module 12.

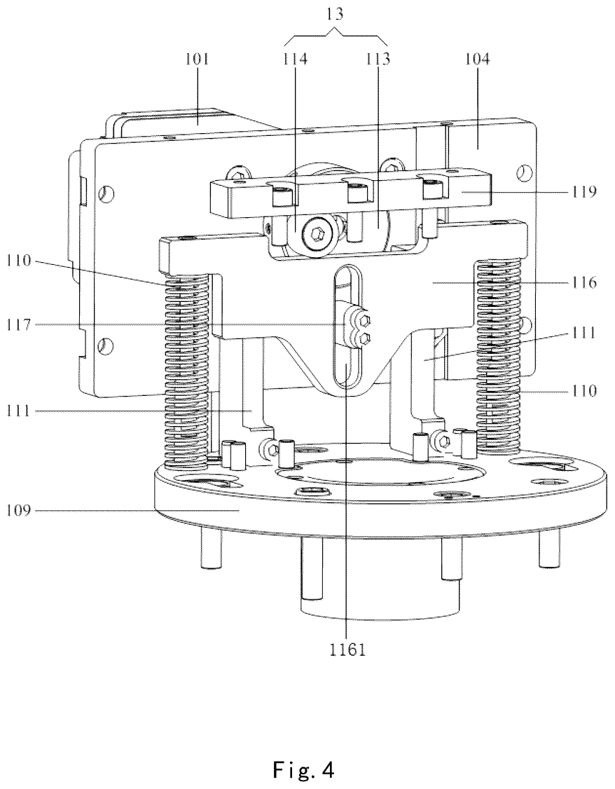

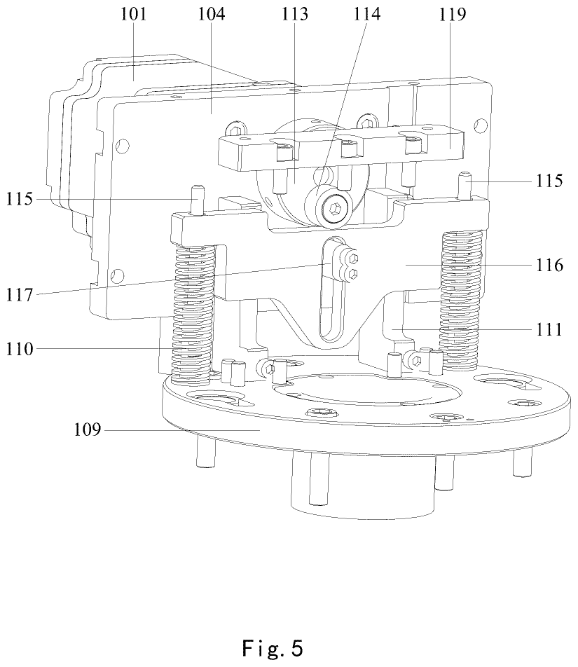

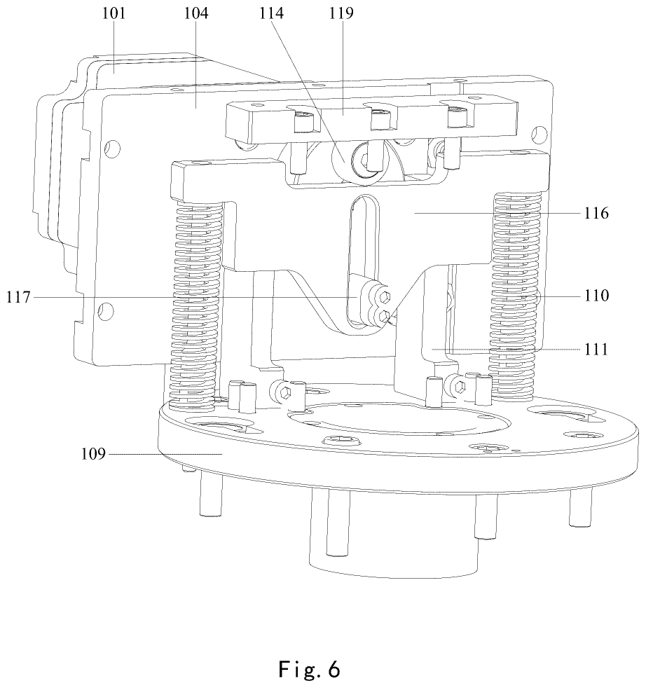

As shown in FIG. 4, AGV drives on the plane, and the transmission mechanism 13 is in a first state as the initial state. In the initial state, the guiding block 117 is disposed in the middle of the sliding slot 1161, as shown in FIG. 4. As shown in FIG. 5, the AGV passes through the concave ground, and the transmission mechanism 13 is in a second state. While the bearing 114 presses the sliding member 116 to move in related to the second connection module 12, and the auxiliary spring 110 is compressed, an end of the sliding slot 1161 moves towards to the guiding block 117, as shown in FIG. 5. As shown in FIG. 6, the AGV passes through the convex ground, and the transmission mechanism 13 is in a third state. While the bearing 114 lifts up the second connection module 12 in related to the first connection module 11, another end of the sliding slot 1161 moves towards to the guiding slot 117, as shown in FIG. 6.

The second connection module 12 is fixed with a guiding pin 115. The sliding member 116 is sleeved on the guiding pin 115, and the auxiliary spring 110 is sleeved on the guiding pin 115.

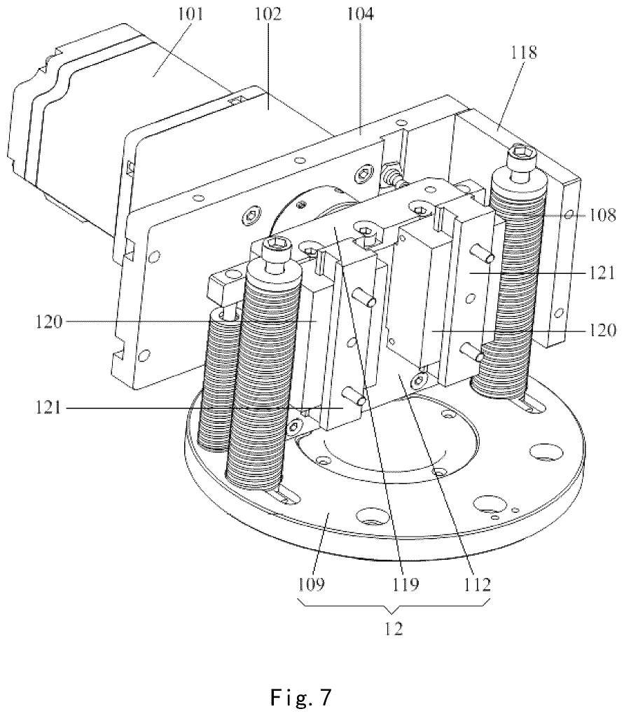

As shown in FIG. 7, for easily assembling the first connection module 11 and the second connection module 12, the first connection module 11 includes a slider 121, and the second connection module 12 includes a slide track 120, and the slide track 120 movably positioned in the slider 121.

An end of the main spring 108 is supported on the top plate 103 of the first connection module 11. The motor 101 and/or the reducer 102 is/are assembled on one of the side plates, and the slider 121 is fixed on another one of the side plates.

In some embodiments, there are four side plates, and the four side plates includes a first side plate 104, a second side plate 105, a third side plate 106, and a fourth side plate 118, which are connected end to end. The motor 101 and/or the reducer 102 is/are fixed on the first side plate 104, and the slider 121 is fixed on the third side plate 106. The motor 101 and the reducer 102 are disposed beside a space surrounded by the side plates and the top plate 103. The rotating disc 113, the bearing 114, and the slider 121 are disposed in the space.

In the second connection module 12, another end of the main spring 108 is supported on the flange 109. The first end of the auxiliary spring 110 is supported on the flange 109. While the second predefined condition is satisfied, the motor 101 drives the transmission mechanism 13 to act and lift up the fixed plate 119, which cause the flange 109 to move towards to the top plate 103, in result that the main spring 108 is compressed.

The sliding member 116 is slidably assembled on the flange 109. The guiding pin 115 is fixed on the flange 109. The flange 109 is fixed with a strengthened rod 111. The sliding member 116 is disposed between the strengthened rod 111 and the vertical plate 112. The guiding block 117 is fixed on the vertical plate 112, and is fixed on a side of the vertical plate 112 facing to the sliding member 116. The slide track 120 is fixed on the vertical plate 112, and is fixed on a side of the vertical plate 112 away from the sliding member 116.

Two ends of the main spring 108 are fixed on the top plate 103 and the flange respectively, or are stuck in a concave of the top plate 103 and a concave of the flange 109 respectively. The connection relationship between the main spring 108 and the top plate 103 and the flange 109 in the present application is not limited. The main spring 108 being reliably supported between the top plate 103 and the flange 109 is assured.

In some embodiments, the sensor 107 is set as a pressure sensor and the motor 101 is set as a servo motor.

The embodiment of the present application also provides an AGV. The AGV includes a vehicle frame 202 and several walking parts 203. At least one walking parts 203 is assembled on the vehicle frame 202 by the suspension system. The suspension system is the suspension system provided by the foregoing embodiments. The first connection module 11 is fixed on the vehicle frame 202, and the walking parts 203 are fixed on the second connection module 12. An outer shell 201 is provided outside the vehicle frame 202.

In some embodiments, the walking parts 203 include walking wheels and driving steering apparatus. Only the driving steering apparatus is assembled on the vehicle frame 202 by the suspension system. In one embodiment, while the AGV breaks down or carries a heavy load, human is unable to move the AGV freely, the second connection module 12 is lifted up to a highest point in related to the first connection module 11 using the transmission mechanism 13. The whole driving steering apparatus gets off the ground by the second connection module 12, only the walking wheels are supported on the ground. Thus, the human is able to freely move a position of the AGV, even in a power-off situation, the motor 101 rotates for getting the whole driving steering apparatus to be off the ground by the second connection module 12 under a control of a quick-change battery an external power, for achieving an aim of freely moving the AGV by the human.

The AGV of the embodiment of the present application used the suspension system of the foregoing embodiments is capable of improving a stability of the vehicle frame 202 while passing through the uneven ground. Also, the AGV of the embodiment of the present application includes other effects of the suspension system of the foregoing embodiments, details are not described herein again.

The embodiment of the present application also provides a suspension control method of the AGV, used in the AGV of the foregoing embodiment. The method includes the following steps.

The sensor 107 senses the main spring 108, and transmits the detection result of the main spring 108 to the controller.

The controller determines whether the detection result is satisfied with the first predefined condition or the second predefined condition according to the detection result of the main spring 108.

While determining the detection result of the main spring 108 to be satisfied with the first predefined condition by the controller, the controller determines that the walking parts 203 pass through the concave ground, the walking parts 203 are the walking parts 203 assembled on the vehicle frame 202 by the suspension system with the main spring 108. The controller controls the motor 101 to drive the transmission mechanism 13 for compressing the second end of the auxiliary spring 110, thus the auxiliary spring 110 is compressed by the transmission mechanism 13. While determining the detection result of the main spring 108 to be satisfied with the second predefined condition by the controller, the controller determines that the walking parts 203 pass through the convex ground, the walking parts 203 are the walking parts 203 assembled on the vehicle frame 202 by the suspension system with the main spring 108. The controller controls the motor 101 to drive the transmission mechanism 13 for lifting up the second connection module 12 in related to the first connection module 11, thus the main spring 108 is compressed.

The foregoing detection result of the sensor 107 includes changes in the supporting force and/or the length of the main spring 108. If the supporting force of the main spring 108 is decreased and/or the length of the main spring 108 gets longer, the first predefined condition is satisfied, the walking parts 203 assembled on the vehicle frame 202 by the suspension system pass through the concave ground. If the supporting force of the main spring 108 is increased and/or the length of the main spring 108 gets shorter, the second predefined condition is satisfied, the walking parts 203 assembled on the vehicle frame 202 by the suspension system pass through the convex ground. The changes of the supporting force and/or the length of the main spring 108 are related to the supporting force and/or the length of the main spring 108 in the initial state.

The suspension control method of the embodiment of the present application used in the AGV with the suspension system is capable of improving the stability of the vehicle frame 202 while passing through the uneven ground. Also, the AGV of the embodiment of the present application includes other effects of the suspension system of the foregoing embodiments, details are not described herein again.

It should be noted that, the embodiments are described herein in a progressive manner. Each embodiment focuses on the difference from another embodiment, and the same and similar parts between the embodiments may refer to each other.

The foregoing of descriptions of the disclosed embodiments enables those skilled in the art to implement or use the present application. Various modifications to these embodiments will be readily apparent to those skilled in the art, and the generic principles defined herein may be implemented in other embodiments without departing form the spirit or scope of the present application. Therefore, the present disclosure is not intended to be limited to the embodiments shown herein, but is to be accorded the widest scope consistent with the principles and novel features disclosed herein.

What is claimed is:

1. A suspension system comprises:
a first connection module;
a second connection module, slidably assembled on the first connection module;
a main spring, supported between the first connection module and the second connection module;
an eccentric module, assembled on the first connection module, the eccentric module comprising an eccentric cam and a motor for driving the eccentric cam to rotate;
a sliding member, slidably assembled on the second connection module, and resisted with the eccentric cam; and
an auxiliary spring, disposed between the sliding member and the second connection module;
wherein the eccentric cam is used to compress the sliding member to move in related to the first connection module; and the auxiliary spring is compressed by the sliding member for compensating a support force of the main spring; the eccentric cam is further used to make the eccentric cam to lift up the second connection module in related to the first connection module, thereby causing the main spring to be compressed.

2. The suspension system according to claim 1, wherein the eccentric cam comprises:
a rotating disc, fixed on an output shaft of the motor; and an axis of the rotating disc being overlapped with an axis of the output shaft; and
a bearing, assembled on the rotating disc; and an axis of the bearing being offset the axis of the rotating disc;
wherein the sliding member resists with the bearing; the rotating disc is driven by the motor to rotate, which causes the bearing to be far away from the first connection module and synchronously compress the sliding member to move in related to the second connection module; in result that the auxiliary spring is compressed by the sliding member for compensating a support force of the main spring; the rotating disc is further driven by the motor to rotate, which causes the eccentric cam to lift up the second connection module in related to the first connection module, in result that the main spring is compressed.

3. The suspension system according to claim 1, wherein the sliding member defines a sliding slot;
the second connection module is fixed with a guiding block; the guiding block inserts into the sliding slot, and is used to guide a sliding direction of the sliding member in related to the second connection module.

4. The suspension system according to claim 1, wherein the second connection module is fixed with a guiding pin; the sliding member is sleeved on the guiding pin, and the auxiliary spring is sleeved on the guiding pin.

5. The suspension system according to claim 1, wherein the first connection module comprises a slider; the second connection module comprises a slide track, and the slide track is movably positioned in the slider.

6. The suspension system according to claim 5, wherein the first connection module further comprises a top plate and several side plates; the side plates are connected end to end; the top plate is fixedly connected with the side plates; an end of the main spring is supported on the top plate of the first connection module; the eccentric module is assembled on one of the side plates, and the slider is fixed on another one of the side plates.

7. The suspension system according to claim 6, wherein the eccentric module and the slider are disposed on two opposite side plates.

8. The suspension system according to claim 7, wherein the second connection module comprises:
a flange;
a vertical plate, fixed on the flange; and
a fixed plate, fixed on the vertical plate; and the fixed plate and the flange being disposed on two opposite ends of the vertical plate;
wherein another end of the main spring is supported on the flange; the sliding member is slidably assembled on the flange; the eccentric cam is used to lift up the fixed plate, for driving the flange to move towards to the top plate and compress the main spring.

9. The suspension system according to claim 8, wherein the flange is fixed with a strengthened rod; the sliding member is disposed between the strengthened rod and the vertical plate.

10. The suspension system according to claim 8, wherein the first connection module is assembled on a vehicle frame of an AGV, at least one walking part of the AGV is assembled on the vehicle frame by the suspension system; the at least one walking part is assembled on the second connection module.

11. A suspension system comprises:
a first connection module;
a second connection module, slidably assembled on the first connection module;
a main spring, supported between the first connection module and the second connection module;
an auxiliary spring, the auxiliary spring comprising a first end and a second end; the second end of the auxiliary spring being disposed on the second connection module;
a motor, assembled on the first connection module;
a transmission mechanism, connected with the motor; the transmission mechanism being acted on the second end of the auxiliary spring; the transmission mechanism drove by the motor is used to compress the auxiliary spring or the main spring;
a sensor, assembled on the first connection module and/or the second connection module for detecting the main spring; and
a controller, wherein:
when the controller determines that a detection result of the sensor is satisfied with a first predefined condition, the controller controls the motor to drive the transmission mechanism for compressing the auxiliary spring;
when the controller determines that the detection result of the sensor is satisfied with a second predefined condition, the controller controls the motor to drive the transmission mechanism for lifting up the second connection module in related to the first connection module, and the main spring is compressed.

12. The suspension system according to claim 11, wherein the transmission mechanism comprises:
a sliding member, slidably assembled on the second connection module; a first end of the auxiliary spring being resisted with the second connection module, and a second end of the auxiliary spring being resisted with the sliding member;
a rotating disc, fixed on an output shaft of the motor; an axis of the rotating disc being overlapped with an axis of the output shaft; and
a bearing, assembled on the rotating disc; an axis of the bearing being offset the axis of the rotating disc,
wherein in the first predefined condition, the motor is used to drive the rotating disc to rotate along an axis of the rotating disc, which cause the bearing to push the sliding member to slide, in result that the auxiliary spring is compressed; in the second predefined condition, the motor is used to drive the rotating disc to rotate along the axis of the rotating disc, which cause the bearing to tightly resist with the second connection module and lift up the second connection module, in result that the main spring is compressed.

13. The suspension system according to claim 12, wherein the sliding member defines a sliding slot; the second connection module is fixed with a guiding block; the guiding block inserts into the sliding slot, and is used to guide a sliding direction of the sliding member in related to the second connection module.

14. The suspension system according to claim 12, wherein the second connection module is fixed with a guiding pin; the sliding member is sleeved on the guiding pin, and the auxiliary spring is sleeved on the guiding pin.

15. The suspension system according to claim 11, wherein the first connection module comprises a slider; the second connection module comprises a slide track, and the slide track is movably positioned in the slider.

16. The suspension system according to claim 15, wherein the first connection module further comprises a top plate and several side plates; the side plates are connected end to end; the top plate is fixedly connected with the side plates; an end of the main spring is supported on the top plate of the first connection module; the eccentric module is assembled on one of the side plates, and the slider is fixed on another one of the side plates.

17. The suspension system according to claim 16, wherein the second connection module comprises:
a flange;
a vertical plate, fixed on the flange; and
a fixed plate, fixed on the vertical plate; the fixed plate and the flange being disposed on two opposite ends of the vertical plate,
wherein another end of the main spring is supported on the flange; the sliding member is slidably assembled on the flange; the eccentric cam is used to lift up the fixed plate, for driving the flange to move towards to the top plate, in result of that the main spring is compressed.

18. A suspension control method of an automatic guided vehicle (AGV), used in an AGV, the AGV comprising a first connection module, a second connection module slidably assembled on the first connection module, a main spring supported between the first connection module and the second connection module, an auxiliary spring comprising a first end and a second end, the first end of the auxiliary spring disposed on the second connection module, a motor assembled on the first connection module, a transmission mechanism connected with the motor, a sensor assembled on the first connection module and/or the second connection module, and a controller; the suspension control method comprises:
sensing the main spring by the sensor, and transmitting a detection result of the main spring to the controller;
determining whether the detection result is satisfied with a first predefined condition or a second predefined condition by the controller according to the detection result of the main spring;
while the controller determines that the detection result of the main spring is satisfied with the first predefined condition by the controller, the controller determines that walking parts pass through a concave ground, the controller controls the motor to drive the transmission mechanism to compress a second end of the auxiliary spring, for compressing the auxiliary spring by the transmission mechanism; and
while the controller determines that the detection result of the main spring is satisfied with the second predefined condition, the controller determines that the walking parts pass through a convex ground, the controller controls the motor to drive the transmission mechanism and lift up the second connection module in related to the first connection module, for compressing the main spring.

19. The suspension control method according to claim 18, wherein the detection result detected by the sensor comprises changes in the supporting force and/or the length of the main spring; when the supporting force of the main spring is decreased and/or the length of the main spring gets longer, the first predefined condition is satisfied, and the controller determines that the walking parts pass through the concave ground; when the supporting force of the main spring is increased and/or the length of the main spring gets shorter, the second predefined condition is satisfied, and the controller determines that the walking parts pass through the convex ground.
